(19) United States
(12) Patent Application Publication
(10) Pub. No.: US 2023/0144589 A1
(43) Pub. Date: May 11, 2023

(54) LED BULB

(71) Applicant: Liquidleds Lighting Corp., Taipei City (TW)

(72) Inventor: David Huang, Taipei City (TW)

(21) Appl. No.: 17/981,397

(22) Filed: Nov. 5, 2022

(30) Foreign Application Priority Data
Nov. 11, 2021 (TW) 110141991

(51) Int. Cl. F21K 9/232; F21V 23/06

(52) U.S. Cl. CPC F21K 9/232; F21V 23/06; F21Y 2103/10

(57) ABSTRACT

An LED bulb has an envelope, an electrical connector, a filament, and at least one electric wire. The envelope is hollow, sealed, and translucent and has a containing portion being enclosed, a neck portion disposed at the containing portion, and an envelope axis passing through the containing portion and the neck portion. The electrical connector is connected to the neck portion. The filament is inside the containing portion, is partially attached to an inner surface of the envelope, and has a light-emitting strip having multiple LEDs and an adhering layer disposed at the light-emitting strip and partially attached to the inner surface of the envelope. The at least one electric wire is electrically connected to the filament and the electrical connector.

### BACKGROUND OF THE INVENTION

### 1. Field of the Invention

The present invention relates to an illumination component, and more particularly to a bulb with a filament having light-emitting diodes (LED).

### 2. Description of Related Art

Referring to FIG. 25, a conventional LED lighting device has a translucent envelope 91 and an LED filament 92. The translucent envelope 91 has an insertion opening 911. The LED filament 92 is inserted in the translucent envelope 91 via the insertion opening 911 and is fixed inside the translucent envelope 91.

Though the insertion opening 911 is helpful to install the LED filament 92, the user can insert a finger into the translucent envelope 91 through the insertion opening 911 and contact the LED filament 92 or bare electric wires 93. The user is prone to electric shock accordingly. In order to avoid risk of electric shock, the translucent envelope 91 of the conventional LED lighting device has to form a specific groove for receiving electric wires 93. Or the LED filament 92 and the electric wires 93 need to be covered by a transparent insulation layer for product safety. Therefore, the conventional LED light device has the following drawbacks:

First, the groove for receiving the LED filament 92 is disposed at the translucent envelope 91, the formation of the groove makes the shape of the translucent envelope 91 complicated, and the options of the shape of the translucent envelope 91 are restricted. Therefore, the translucent envelope 91 of the conventional LED lighting device is difficult to be produced and has high manufacturing cost.

Secondly, the transparent insulation layer for covering the LED filament 92 interferes with heat dissipation of the LED filament 92. The power of the LED filament 92 has to be limited for sustaining service life of the LED filament 92.

Thirdly, the transparent insulation layer still absorbs some light, so the luminous efficiency of the LED filament 92 is reduced.

Fourthly, the LED filament 92 covered by the transparent insulation layer is hard and is difficult to be bent. That is, the LED filament 92 tends to be straight. The LED filament 92 is difficult to be fixed to the translucent envelope 91 with curvatures or corners. And the LED filament 92 is easily detached from the translucent envelope 91 after a period of use.

Therefore, the conventional LED lighting device has to be improved.

### SUMMARY OF THE INVENTION

The main objective of the present invention is to provide an LED bulb that avoids risk of electric shock and prolongs the service life of the LED bulb.

An LED bulb has an envelope, an electrical connector, a filament, and at least one electric wire. The envelope is hollow, sealed, and translucent and has a containing portion being enclosed, a neck portion disposed at the containing portion, and an envelope axis passing through the containing portion and the neck portion. The electrical connector is connected to the neck portion. The filament is inside the containing portion, is partially attached to an inner surface of the envelope, and has a light-emitting strip having multiple LEDs and an adhering layer disposed at the light-emitting strip and partially attached to the inner surface of the envelope. The at least one electric wire is electrically connected to the filament and the electrical connector.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of an LED bulb in accordance with the present invention;

FIG. 2 is a partial cross-sectional side view of the LED bulb in FIG. 1;

FIG. 3 is a side view of the LED bulb in FIG. 1;

FIG. 4 is an operational side view of the LED bulb in FIG. 1 showing a diminished and inverted real image, inside the envelope, formed by the light emitted by a filament; and

FIG. 5 is an operational side view of a second embodiment of the LED bulb in accordance with the present invention and shows a diminished and inverted real image, inside the envelope, formed by the light emitted by a filament;

FIG. 6 is an operational side view of a third embodiment of the LED bulb in accordance with the present invention and shows a diminished and inverted real image, inside the envelope, formed by the light emitted by a filament;

FIG. 7 is an operational side view of a fourth embodiment of the LED bulb in accordance with the present invention and shows a diminished and inverted real image, inside the envelope, formed by the light emitted by a filament;

FIG. 8 is a side view of a fifth embodiment of the LED bulb in accordance with the present invention;

FIG. 9 is another side view of the fifth embodiment of the LED bulb in accordance with the present invention;

FIG. 10A is a perspective view of a sixth embodiment of the LED bulb in accordance with the present invention;

FIG. 10B is a side view of the sixth embodiment of the LED bulb in accordance with the present invention;

FIG. 11 is a top view of the sixth embodiment of the LED bulb in accordance with the present invention;

FIG. 12 is a top view of a seventh embodiment of the LED bulb in accordance with the present invention;

FIG. 13 is a side view of the seventh embodiment of the LED bulb in accordance with the present invention;

FIG. 14 is a side view of an eighth embodiment of the LED bulb in accordance with the present invention;

FIG. 15 is a top view of the eighth embodiment of the LED bulb in accordance with the present invention;

FIG. 16A is a perspective view of a ninth embodiment of the LED bulb in accordance with the present invention;

FIG. 16B is a side view of the ninth embodiment of the LED bulb in accordance with the present invention;

FIG. 17 is a top view of the ninth embodiment of the LED bulb in accordance with the present invention;

FIG. 18 is an enlarged cross-sectional side view of the filament of the LED bulb in accordance with the present invention, showing detailed structures of the filament;

FIG. 19 is a partial side view of an eleventh embodiment of the LED bulb in accordance with the present invention;

FIG. 20 is a partial cross-sectional side view of the eleventh embodiment of the LED bulb in accordance with the present invention;

FIGS. 21 and 22 are operational cross-sectional side views of the eleventh embodiment of the LED bulb in accordance with the present invention along line A-A in FIG. 20;

FIG. 23 is a side view of a tenth embodiment of the LED bulb in accordance with the present invention;

FIG. 24 is a top view of the tenth embodiment of the LED bulb in accordance with the present invention; and

FIG. 25 is a perspective view of a conventional LED lighting device.

### DETAILED DESCRIPTION OF PREFERRED EMBODIMENTS

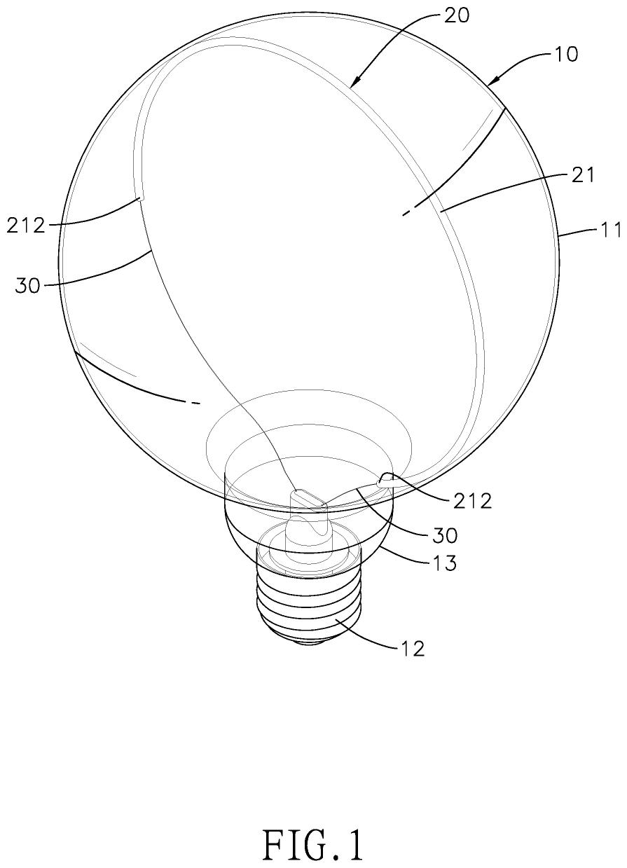

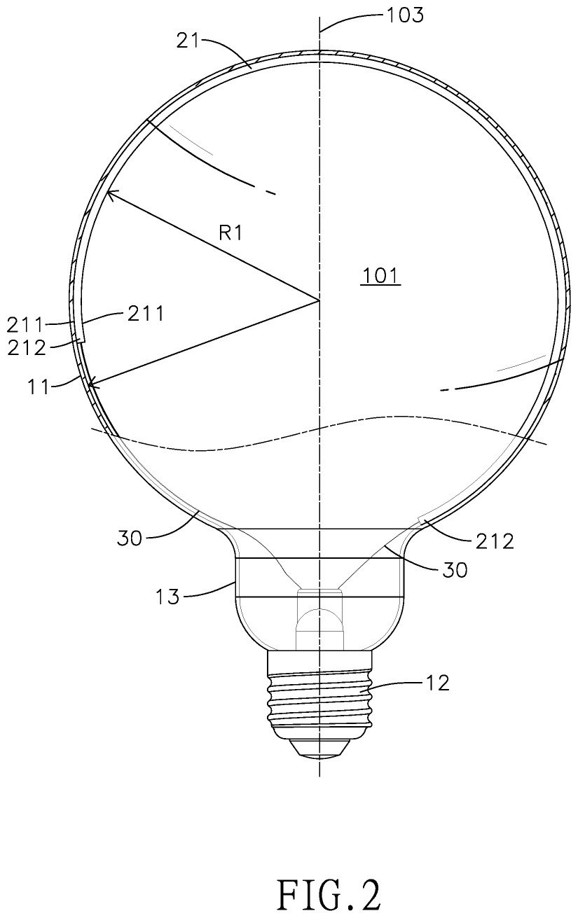

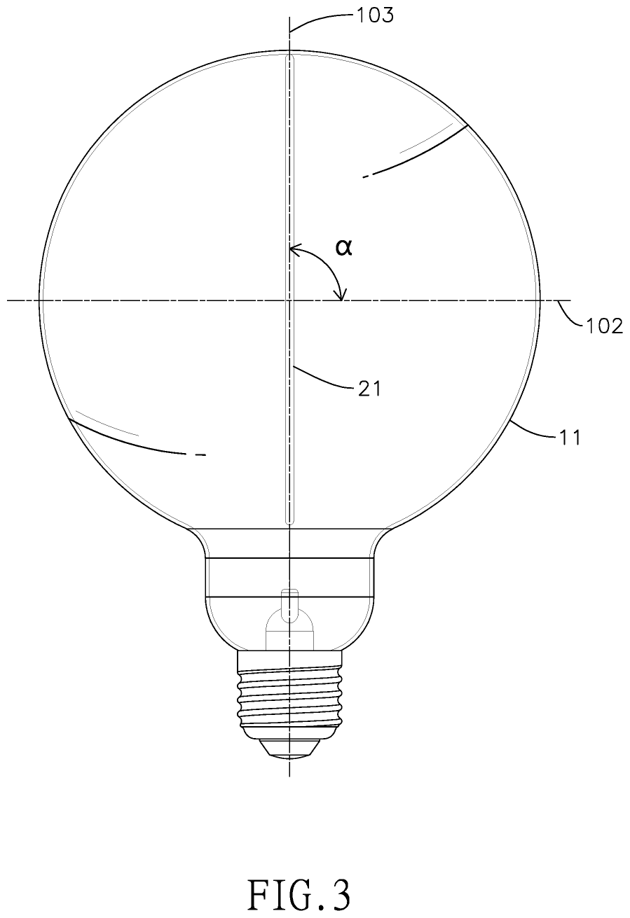

With reference to FIGS. 1 to 3, a first embodiment of an LED bulb in accordance with the present invention has an envelope 10, an electrical connector 12, a filament 20, and two electric wires 30.

The envelope 10 is a hollow, sealed, and translucent shell. That is, gas cannot enter or exit the envelope 10. The envelope 10 has a containing portion 11 and a neck portion 13. The containing portion 11 is enclosed to form a filament space 101. In the first embodiment, the containing portion 11 is an outward protruding shell being translucent and curved. Specifically, the containing portion 11 is shaped as a ball. As long as the containing portion 11 encloses the filament space 101, the shape of the containing portion 11 is not restricted.

The neck portion 13 is disposed at a side of the containing portion 13. A width of the neck portion 13 is smaller than a width of the containing portion 11. A linking line connects the containing portion 11 and the neck portion 13 is defined as an envelope axis 103. That is, the envelope axis 103 is a line substantially passing through a center of the containing portion 11 and a center of the neck portion 13. Besides being shaped as a ball, the containing portion 11 may be shaped as a regular solid geometry being symmetric along the envelope axis 103 such as a regular polygon, a cylinder, a cone, a dish, or an oval.

The electrical connector 12 is connected to the neck portion 13 of the envelope 10. The electrical connector 12 is configured to connect to an external power source to conduct power for the filament 20. Ideally, the electrical connector 12 may be screwed with or engage with a power supply socket which does not belong to the present invention. Preferably, the electrical connector 12 is adapted to lamp holders according to regular specifications such as E14, E27, B22, or GU10 lamp holders. In the first embodiment, the electrical connector 12 is directly fixed to the neck portion 13, but it is not limited thereto. The electrical connector 12 can be just wires. Alternatively, in a tenth embodiment of the present invention, the electrical connector 12 is able to rotate relative to the neck portion 13.

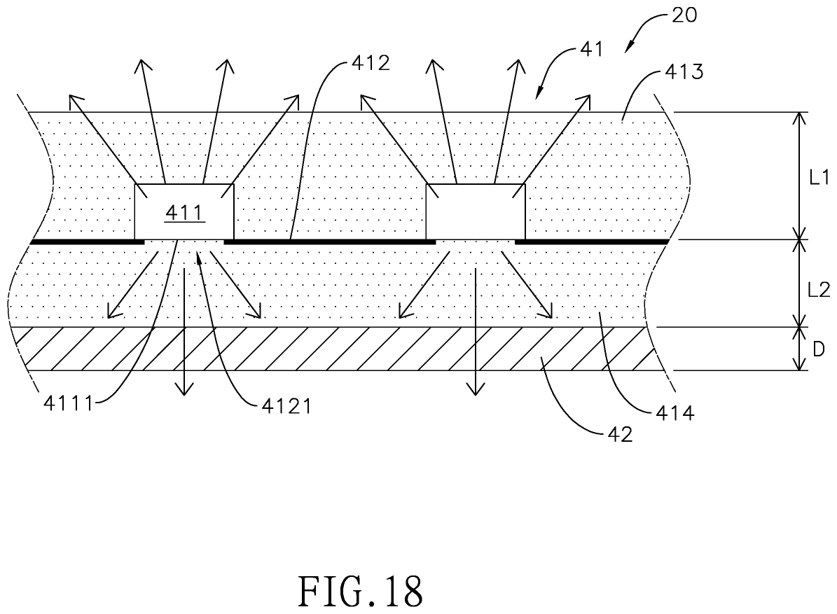

The filament 20 is disposed within the filament space 101 of the envelope 10 and is partially attached to an inner surface of the envelope 10. The filament 20 is electrically connected to the electrical connector 12 via the two electric wires 30. With reference to FIG. 18, the filament 20 is flexible and has a light-emitting strip 41 and an adhering layer 42. The light-emitting strip 41 has multiple light-emitting diodes (LEDs) 411 disposed inside the light-emitting strip 41. The adhering layer 42 is disposed at a side of the light-emitting strip 41 and is partially attached to the inner surface of the envelope 10. That is, the filament 20 is attached to the inner surface of the envelope 10 via the adhering layer 42. Practically, each electric wire 30 may have multiple cores.

Specifically, with reference to FIG. 18, the light-emitting strip 41 further has a conductive framework 412, a top encapsulating layer 413, and a bottom encapsulating layer 414. The conductive framework 412 is an elongated metal sheet. The conductive framework 412 has a front side and a back side facing to opposite directions. The multiple LEDs 411 are disposed at the front side of the conductive framework 412. A thickness of the filament 20 can be further reduced via deploying the multiple LEDs 411 at a same side of the conductive framework 412. Accordingly, the flexibility of the filament 20 is further enhanced and the filament 20 can be fixed to the envelope 10 easier. Preferably, the conductive framework 412 has multiple openings 4121.

With reference to FIG. 18, the top encapsulating layer 413 and the bottom encapsulating layer 414 respectively cover the front side and the back side of the conductive framework 412. The top encapsulating layer 413 and the bottom encapsulating layer 414 are both translucent and both have special chemical materials therewithin for turning light emitted from the multiple LEDs 411 into light in various colors. For example, a blue light can be transferred into a white light or a yellow light. The adhering layer 42 is disposed at a side, opposite to the conductive framework 412, of the bottom encapsulating layer 414. Preferably, the adhering layer 42 may be translucent. A thickness L2 of the bottom encapsulating layer 414 is smaller than a thickness L1 of the top encapsulating layer 413, and thereby the light-emitting strip 41 can be easily bended toward a direction to which the top encapsulating layer 413 faces. That is, the top encapsulating layer 413 is disposed at a side facing to a curvature center of the light-emitting strip 41. A thickness D of the adhering layer 42 is smaller than a quarter of a sum of the thickness L1 of the top encapsulating layer 413 and the thickness L2 of the bottom encapsulating layer 414. The thickness D of the adhering layer 42 is smaller than 2 millimeters. The light-emitting strip 41 can be easily bended toward the direction to which the top encapsulating layer 413 faces and can be easily attached to the envelope 10. The heat generated by the multiple LEDs 411 can be rapidly dissipated from the envelope 10 via the adhering layer 42.

In the first embodiment, the filament 20 emits light via both the front and the back sides of the filament 20. That is, each LED 411 has two diode emitting faces 4111. The two diode emitting faces 4111 of each LED 411 are respectively disposed at two opposite sides thereof. One of the diode emitting faces 4111 faces to the conductive framework 412. Each LED 411 emits light from the two diode emitting faces 4111. The multiple LEDs 411 respectively correspond to the multiple openings 4121 of the conductive framework 412 in position. Said one diode emitting face 411, of each LED 411, facing to the conductive framework 412, emits light through a respective one of the openings 4121 and makes the filament 20 emit light via both sides of the filament 20.

With reference to FIGS. 1 to 3, the filament 20 has an elongation direction and a curved attaching section 21 along the elongated direction of the filament 20. The curved attaching section 21 is attached to the inner surface of the envelope 10 and is shaped as an arc. The curved attaching section 21 circles around an imaginary filament circling line 102. The filament circling line 102 is an imaginary line passing through the filament space 101. By attaching the curved attaching section 21 to an inner surface of the containing portion 11 of the envelope 10, heat generated by the curved attaching section 21 can be conducted to and dissipated from the envelope 10. The temperature of the filament 20 is decreased, and the service life of the present invention is prolonged accordingly. Further, inside of the filament space 101 is filled with helium gas preferably. The heat dissipation of the filament 20 is further promoted by the helium gas with high thermal conductivity to prolong the service life of the present invention.

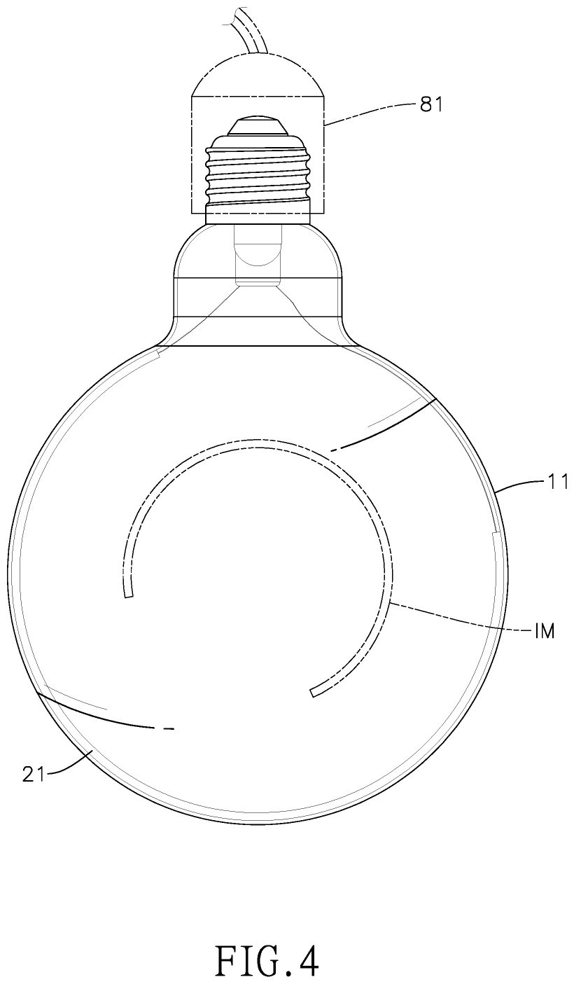

With reference to FIG. 4, the curved attaching section 21 circles the filament circling line 102. By which, when the user is adjacent to an extension line of the filament circling line 102, the light emitted from the curved attaching section 21 is reflected by the inner surface, being curved, of the containing portion 11. A diminished inverted real image IM is formed at a position further adjacent to the filament circling line 102 by the light emitted from the curved attaching section 21. The diminished inverted real image IM, of the curved attaching section 21, seems to float in the envelope 10, displaying a unique sense of beauty. Therefore, the present invention can present the floating real image IM without other special structures such as an additional filament. The manufacturing cost of the present invention is reduced accordingly.

In the first embodiment, the curved attaching section 21 further has two emitting faces 211 respectively disposed at two opposite sides of the curved attaching section 21. Each emitting face 211 extends to two opposite ends 212 of the curved attaching section 21. One of the two emitting faces 211 is attached to the inner surface of the containing portion 11. The light, emitted from the other one of the two emitting faces 211 facing opposite to the inner surface of the containing portion 11, is more easily reflected by other regions of the inner surface of the containing portion 11 to form the abovementioned diminished inverted real image IM floating inside the envelope 10. The illumination of the real image IM is increased to further enhance the beauty of the present invention.

In addition, the curved attaching section 21 has only one curvature R1. That is, the curved attaching section 21 is a part of a circle and has only one center of curvature rather than a curve in an arbitrary shape. In the first embodiment, the center of curvature of the curved attaching section 21 is disposed at a center of the containing portion 11 of the envelope 10.

In the first embodiment, the filament circling line 102 passes through the center of the containing portion 11. An included angle α defined between the filament circling line 102 and the envelope axis 103 is greater than or equal to 85 degrees and is smaller than or equal to 95 degrees. That is, the filament circling line 102 is substantially perpendicular to the envelope axis 103. The curved attaching section 21 extends along the inner surface of the containing portion 11 over 180 degrees. One of the two ends of the curved attaching section 21 is more adjacent to the electrical connector 12 connected to the envelope 10 than the other one of the two ends of the curved attaching section 21. A ratio of the curvature R1 of the filament 20 and an inside diameter R2 of the containing portion 11 is larger than or equal to 0.98 and is smaller than or equal to 1. That is, the curved attaching section 21 substantially circles the center of the containing portion 11 shaped as a ball. By which, when the present invention is hung below a power supply socket 81, the curved attaching section 21 is substantially an oblique curve at a vertical plane. The real image IM observed by the user along the filament circling line 102 is similar to a crescent moon in the night sky and further enhances the beauty of the present invention.

The two electric wires 30 are elongated metal bare wires. The electric wires 30 are electrically connected to the filament 20 and the electrical connector 12. Preferably, the electric wires 30 and the inner surface of the envelope 10 are spaced apart. That is, the electric wires 30 and the envelope 10 are free from contacting each other. Whereby, when the filament 20 emits light, the electric wires 30 are hardly visible to the user. The electric wires 30 can be hidden and the present invention is more aesthetic in visual appeal.

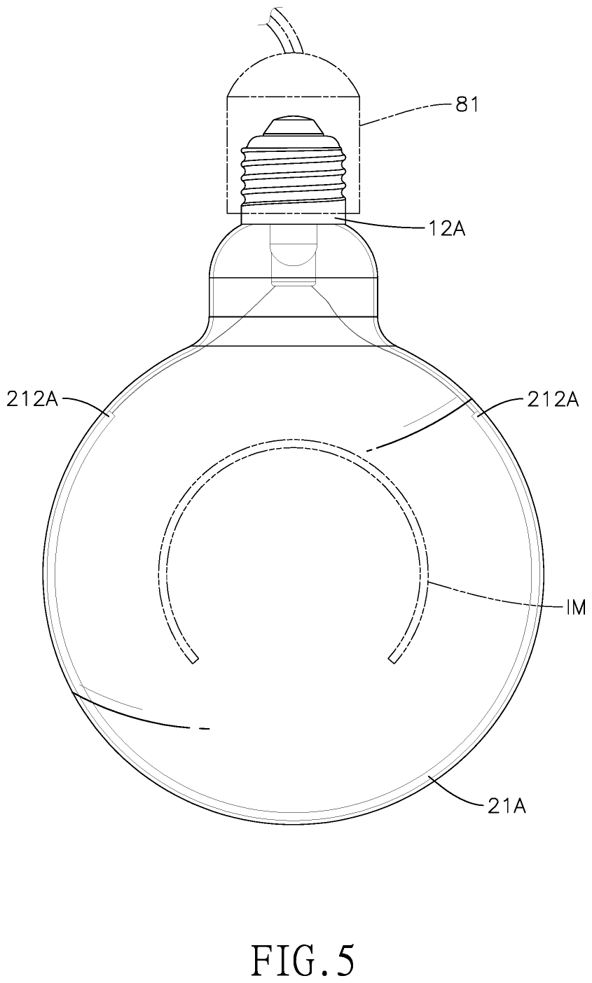

With reference to FIG. 5, a second embodiment of the present invention is similar to the first embodiment. Difference between the first and the second embodiments is that both the two ends 212A of the curved attaching section 21A are spaced from the electrical connector 12A connected to the envelope 10A by a same distance. That is, the electrical connector 12A connected to the envelope 10A is disposed at a center between the two ends 212A of the curved attaching section 21. The real image IM presented by the second embodiment shows beauty in symmetry.

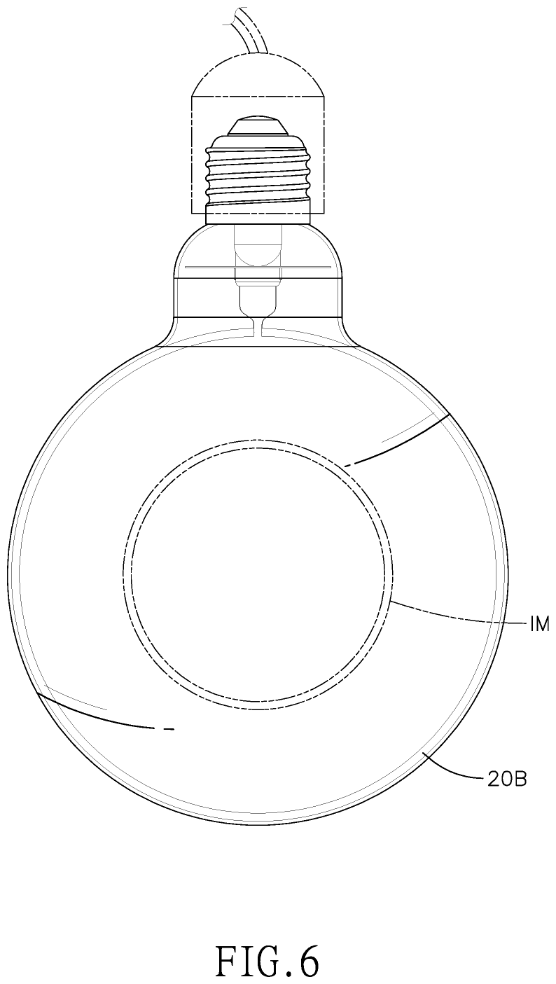

With reference to FIG. 6, a third embodiment of the present invention is similar to the first embodiment. Difference between the third and the first embodiments is that the filament 20B circles the filament circling line 102 about degrees. In the third embodiment, the filament 20B generates a real image IM substantially shaped as a circle.

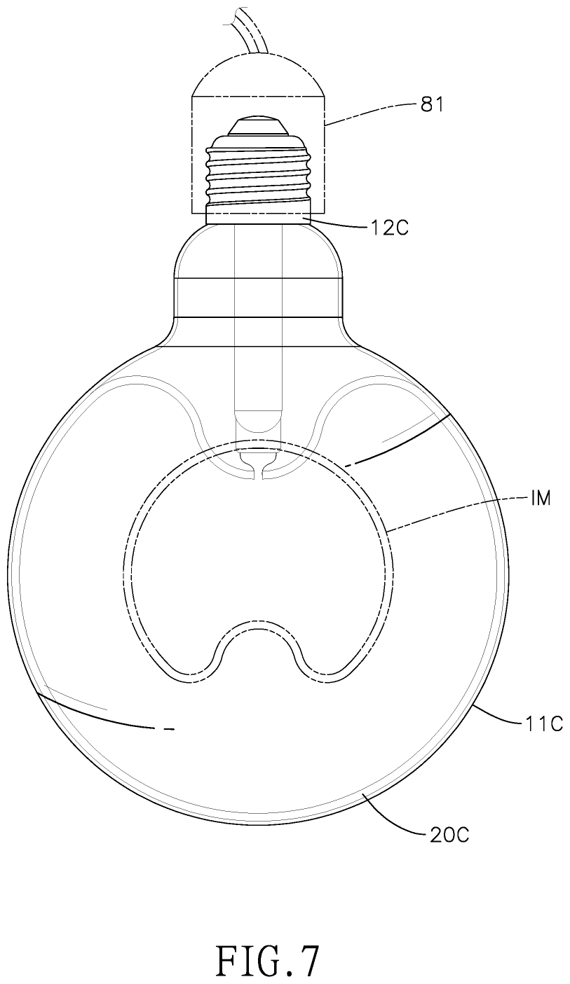

With reference to FIG. 7, a fourth embodiment of the present invention is similar to the third embodiment. Difference between the third and the fourth embodiments is that two ends of the filament 20C further approach the center of the containing portion 11C. Therefore, an outline of the filament 20C overlaps the real image IM generated by the fourth embodiment.

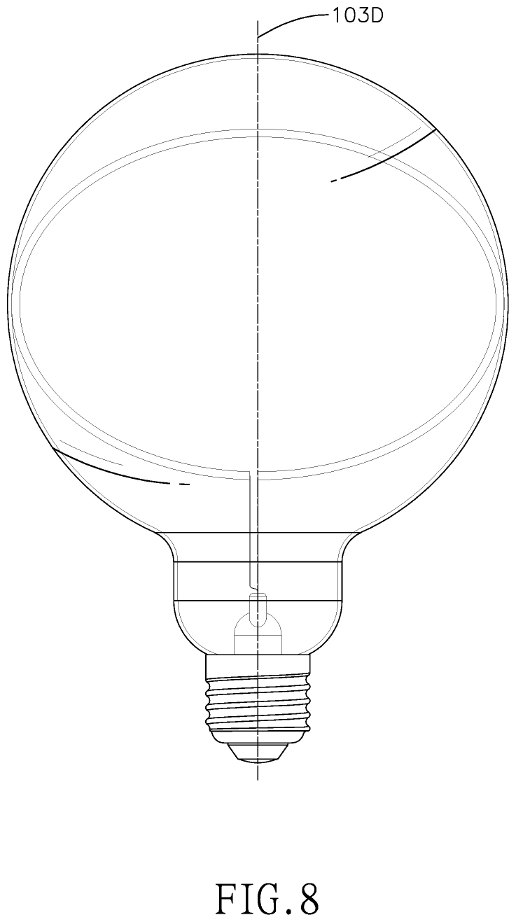

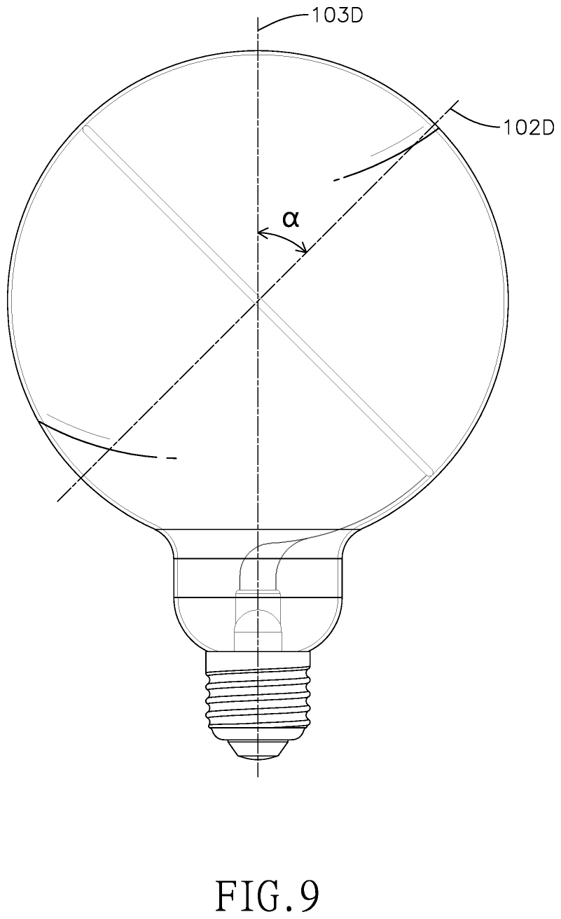

With reference to FIGS. 8 and 9, a fifth embodiment of the present invention is similar to the third embodiment. Difference between the third and the fifth embodiments is that the included angle α defined between the filament circling line 102D and the envelope axis 103D is greater than or equal to 40 degrees and is smaller than or equal to 50 degrees.

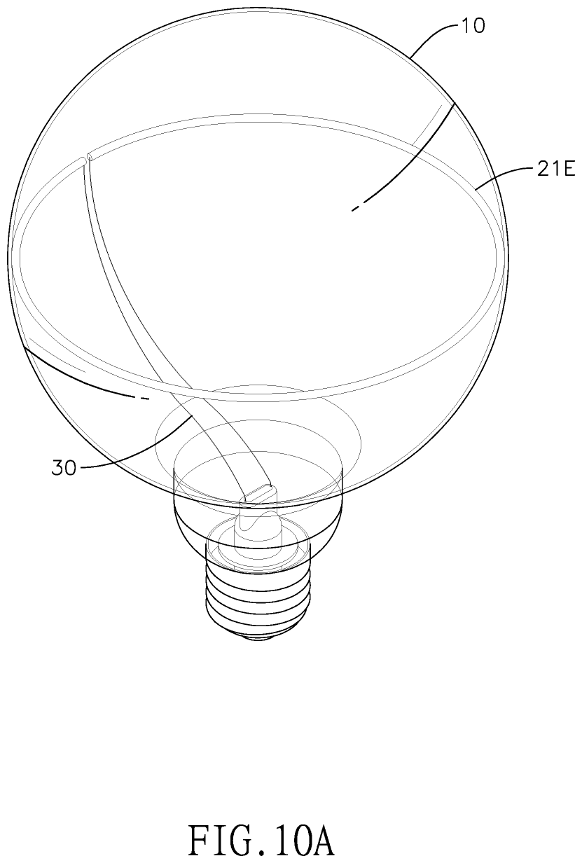

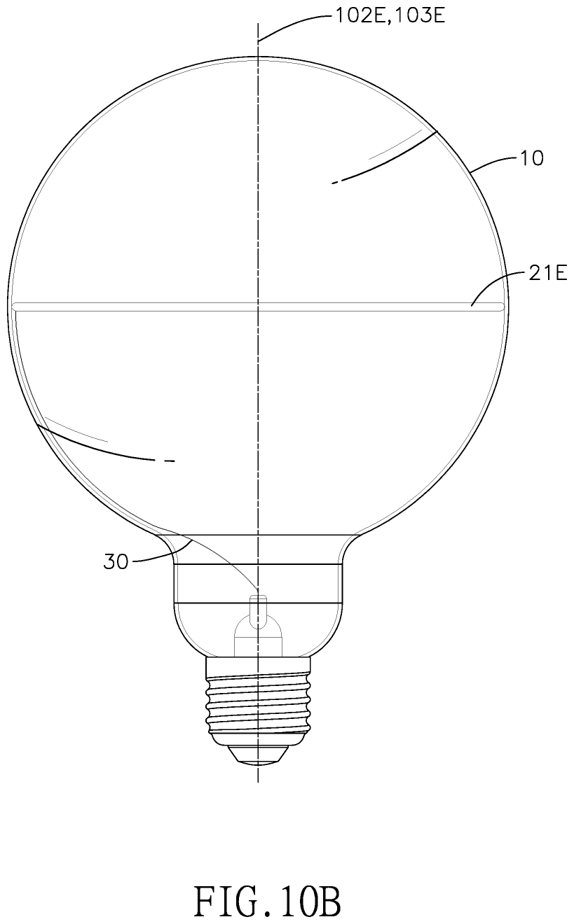

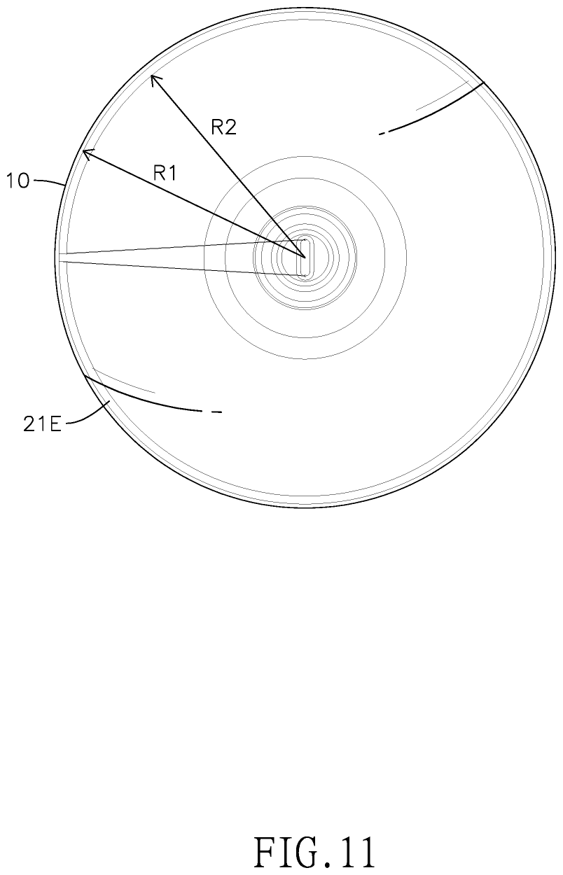

With reference to FIGS. 10A, 10B, and 11, the sixth embodiment of the present invention is similar to the fourth embodiment. Difference between the fourth and the sixth embodiments is that the included angle α defined between the filament circling line 102E and the envelope axis 103E is smaller than 5 degrees. That is, the filament circling line 102E and the envelope axis 103E are substantially parallel to each other and are substantially collinear. When the sixth embodiment is hung below the power supply socket 81, the curved attaching section 21E is substantially a circle at a horizontal plane.

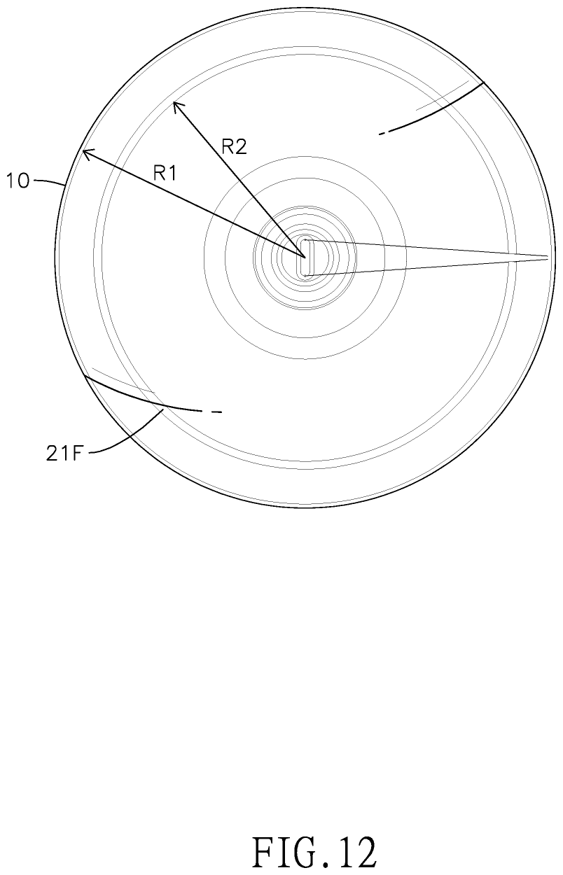

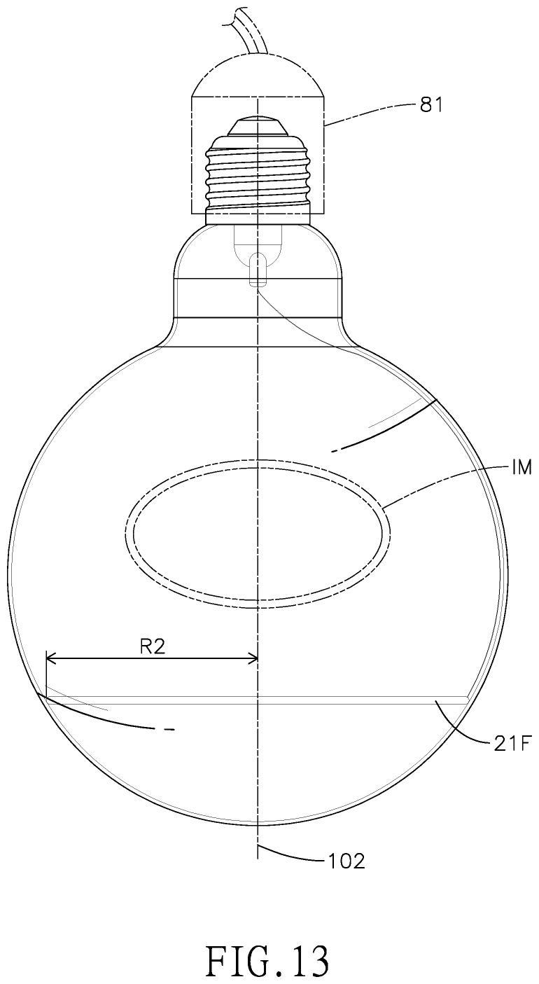

With reference to FIGS. 12 and 13, a seventh embodiment of the present invention is similar to the sixth embodiment. Difference between the sixth and the seventh embodiments is that the ratio of the curvature R1 of the curved attaching section 21F and the inner diameter R2 of the containing portion 11F is larger than or equal to 0.84 and is smaller than or equal to 0.88. That is, the curved attaching section 21F deviates from the center of the containing portion 11F shaped as a ball. The real image IM generated by the seventh embodiment is oval accordingly. A linking line connecting one of the two ends of the curved attaching section 21F and the center of the containing portion 11F define an included angle about 60 degrees, but it is not limited thereto. In other embodiments, the ratio of the curvature R1 of the curved attaching section 21F and the inner diameter R2 of the containing portion 11F is larger than or equal to 0.68 and is smaller than or equal to 0.72, or the ratio is larger than or equal to 0.48 and is smaller than or equal to 0.52. By which, an included angle between the linking line connecting one of the two ends of the curved attaching section 21F and the center of the containing portion 11F and the filament circling line 102F is about 45 degrees or 30 degrees.

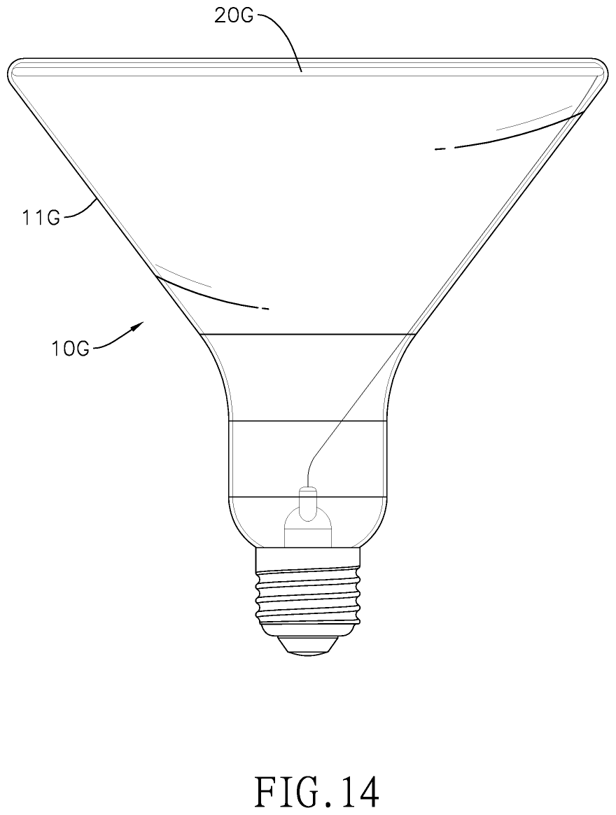

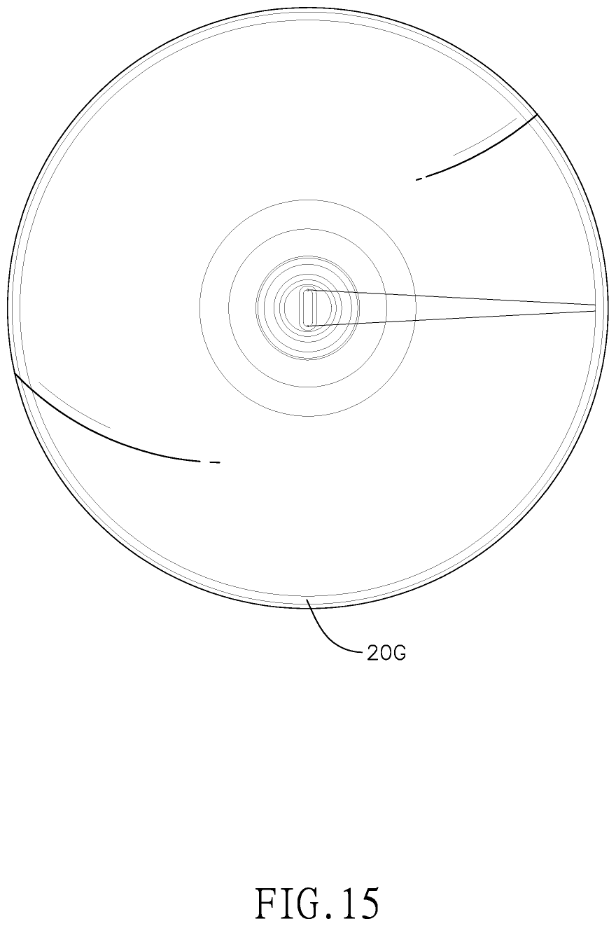

With reference to FIGS. 14 and 15, an eighth embodiment of the present invention is similar to the first embodiment. Difference between the first and the eighth embodiments is that the containing portion 11G of the envelope 10G is conical, the filament 20G attached to the inner surface of the envelope 10G forms a closed loop. Specifically, the filament 20G is looped as a complete circle.

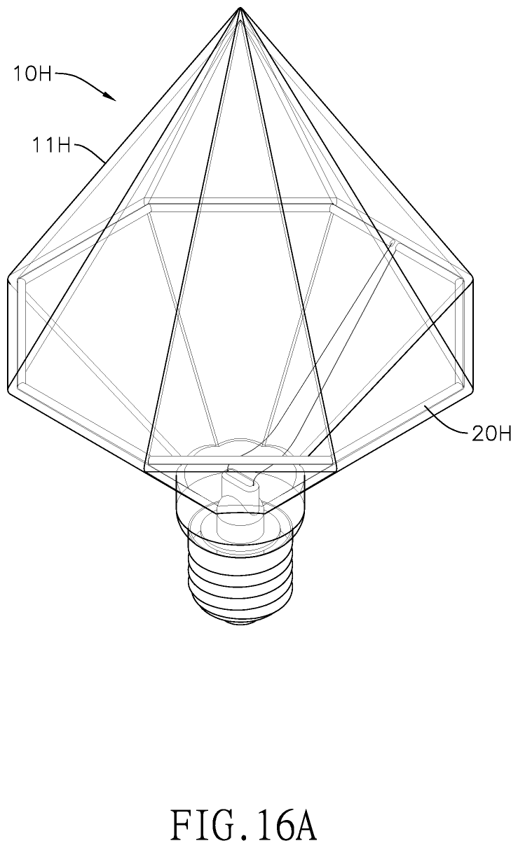

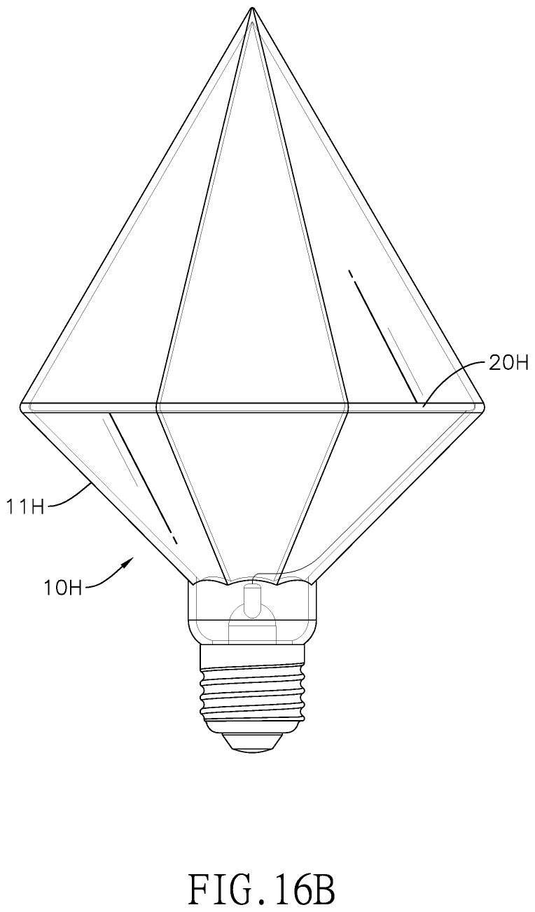

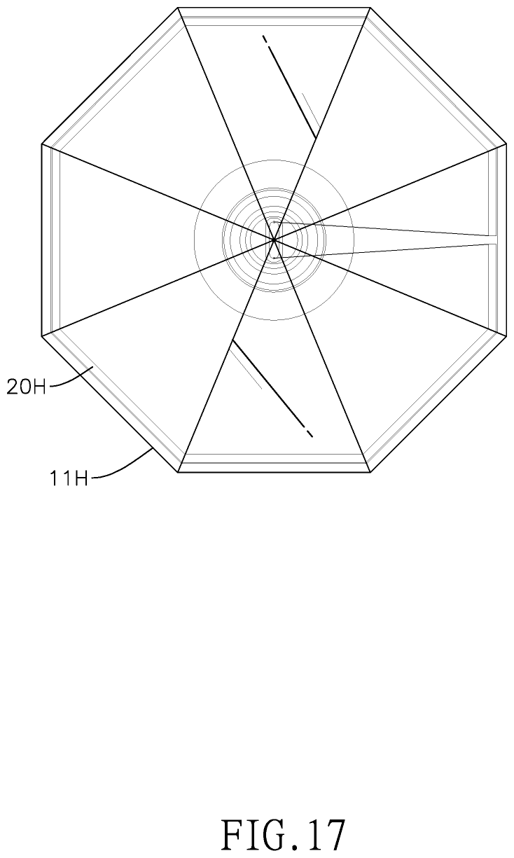

With reference to FIGS. 16A, 16B, and 17, a ninth embodiment of the present invention and the first embodiment are similar. Difference between the first and the ninth embodiments is that the containing portion 11H of the envelope 10H is polygonal. Specifically, a cross-section of the containing portion 11H of the envelope 10H is octagonal. The filament 20H forms a closed loop being a complete octagon. The filament 20H is completely attached to the inner surface of the containing portion 11H of the containing portion 10H.

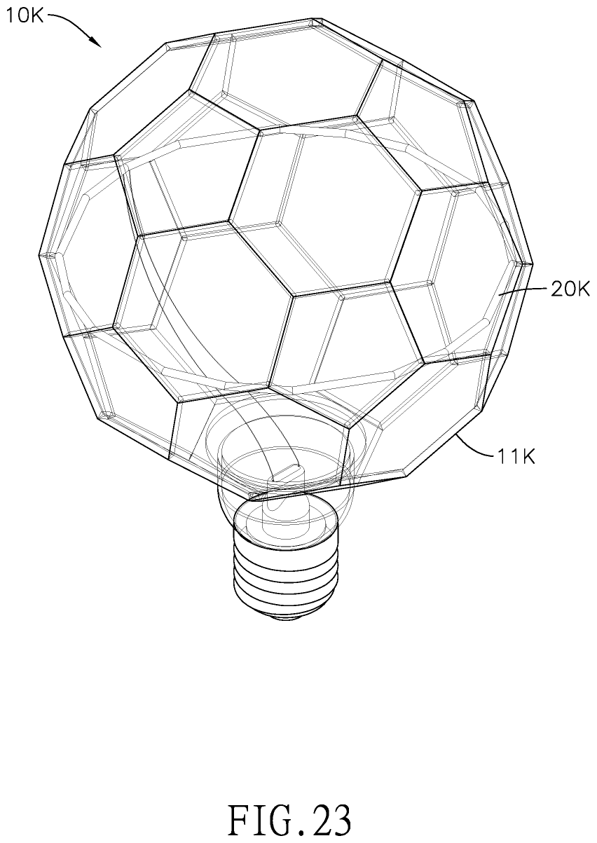

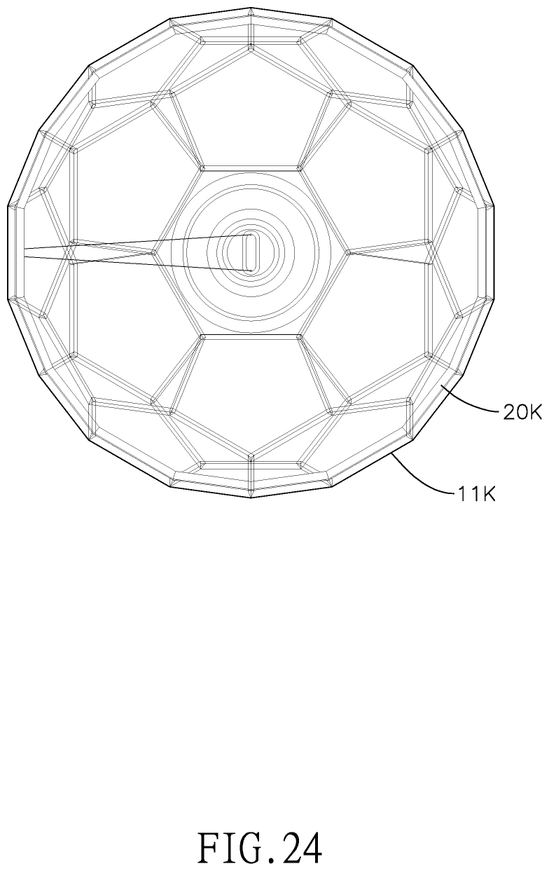

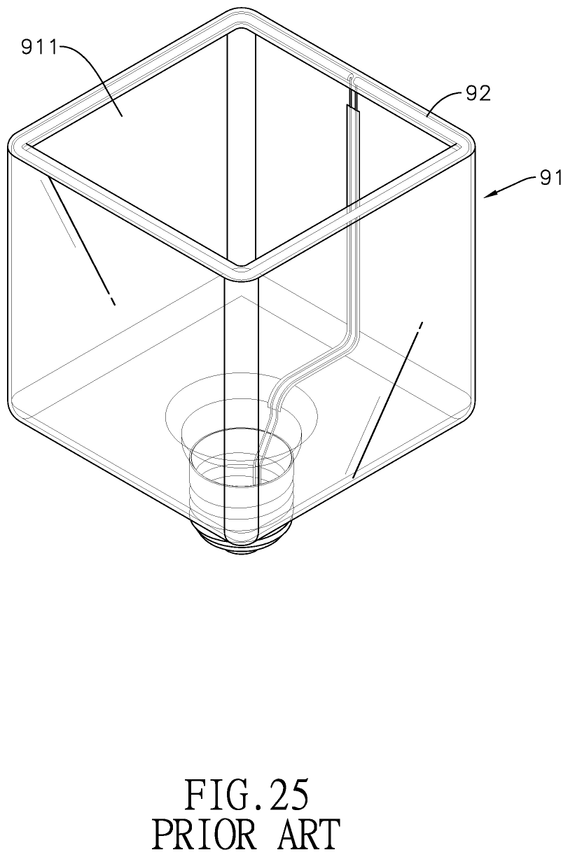

With reference to FIGS. 23 and 24, the tenth embodiment and the ninth embodiment are similar. Difference between the ninth and the tenth embodiments is that the containing portion 11K of the envelope 10K is a semiregular polyhedron composed by multiple regular pentagonal faces and multiple regular hexagonal faces. In other words, shape inside the containing portion 11K is similar to a soccer ball. The filament 20K is looped into a closed loop, and the filament 20K is completely attached to the inner surface of the containing portion 11K.

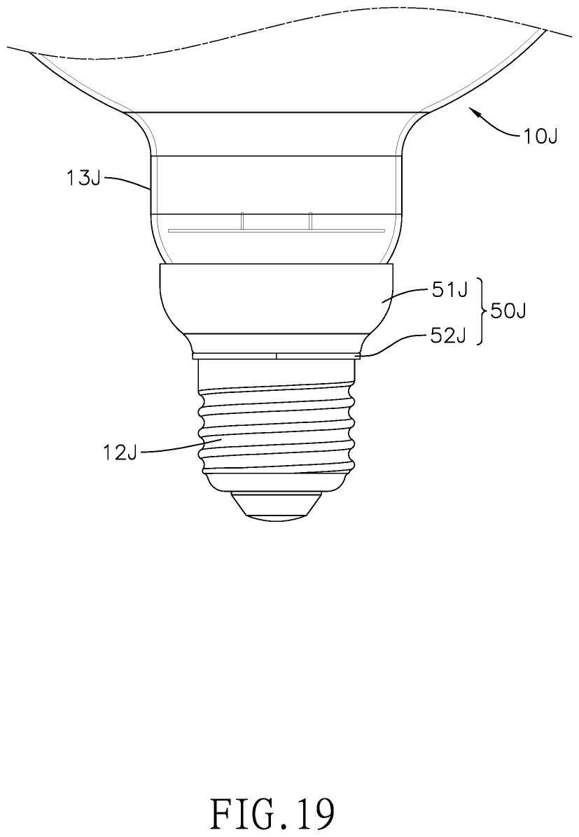

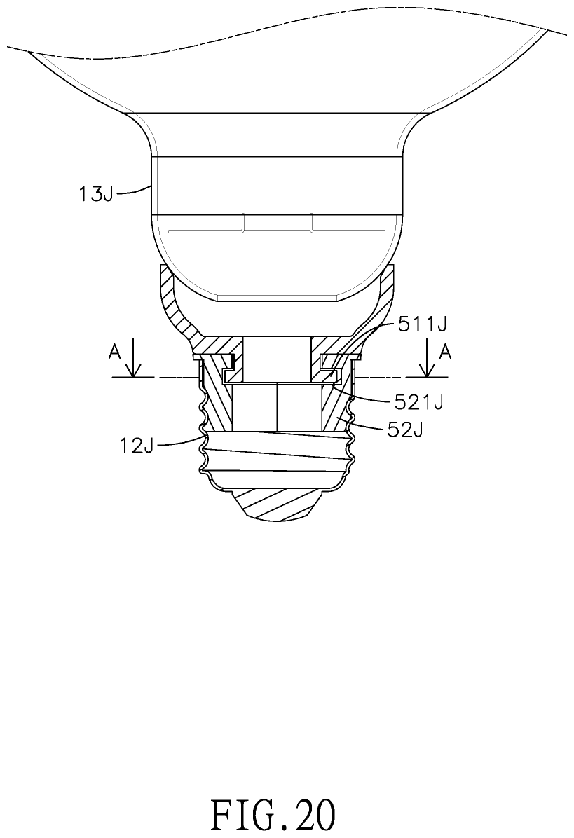

With reference to FIGS. 19 and 20, an eleventh embodiment of the present invention and the first embodiment are similar. Difference between the tenth and the first embodiments is that the LED bulb of the present invention further has a rotation mechanism 50J. The rotation mechanism 50J is disposed between the electrical connector 12J and the envelope 10J to make the electrical connector 12J rotatable relative to the envelope 10J.

The rotation mechanism 50J connected between the envelope 10J and the electrical connector 12J has an envelope connecting portion 51J and a base connecting portion 52J. The envelope connecting portion 51J is disposed at the neck portion 13J of the envelope 10J. Specifically, the envelope connecting portion 51J is directly connected to the neck portion 13J. The base connecting portion 52J is rotatably connected to the envelope connecting portion 51J. The electrical connector 12J is disposed at the base connecting portion 52J. Specifically, the electrical connector 12J is directly fixed to the base connecting portion 52J. By which, when the electrical connector 12J is fixed to the power supply socket that does not belong to the present invention and is free from rotating relative to the power supply socket, the envelope 10J still can be angularly adjusted. The filament 20J can face to the user at an ideal observation angle accordingly.

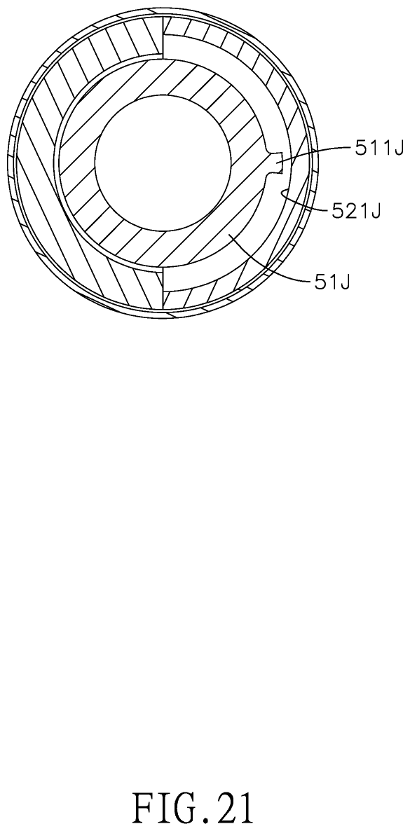

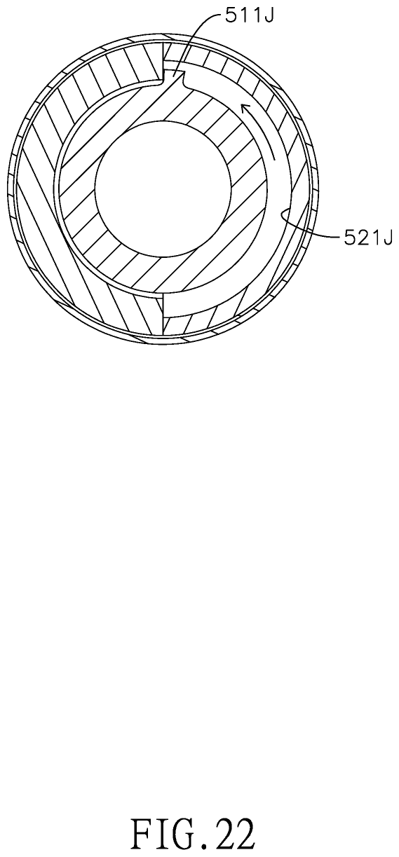

With reference to FIGS. 20 to 22, in the eleventh embodiment, the envelope connecting portion 51J has a limiting protrusion 511J and a limiting circular groove 521J. The limiting protrusion 511J protrudes from an outer peripheral surface of the envelope connecting portion 51J. The limiting annular groove 521J is formed in an inner peripheral surface of the envelope connecting portion 51J. When the base connecting portion 52J is rotated relative to the envelope connecting portion 51J to a particular angle, the limiting protrusion 511J is able to abut against one of two ends of the base connecting portion 52J. By which, an angular range of the rotation of the base connecting portion 52J relative to the envelope connecting portion 51J is limited. In the eleventh embodiment, the base connecting portion 52J can be rotated relative to the envelope connecting portion 51J under 180 degrees, but it is not limited thereto. As long as the base connecting portion 52J is rotated relative to the envelope connecting portion 51J under 360 degrees, the protection of the electric wires can be effectively achieved.

In summary, in the present invention, the filament 20 is sealed in the filament space 101 of the envelope 10 to completely prevent the user from risk of electric shock due to contacting the filament 20 or the electric wires 30. Therefore, the groove for receiving the filament 20 is unnecessary, the options of the shape of the envelope 10 is increased and the manufacturing cost of the present invention is reduced. Further, the filament 20 is directly attached to the inner surface of the envelope 10 to enhance the heat dissipation of the present invention to allow adaption of the filaments with high power to increase the illumination of the present invention. In addition, the filament 20 is easily to be bended to be fixed to the envelope 10 during manufacturing, the service life of the filament 20 is prolonged, and the filament 20 will not easily detach from the envelope 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A light-emitting diode (LED) bulb configured to connect to an external power source and comprising:
an envelope being a hollow, sealed, and translucent shell and having
a containing portion being enclosed to form a filament space;
a neck portion disposed at a side of the containing portion; and
an envelope axis passing through the containing portion and the neck portion;
an electrical connector connected to the neck portion of the envelope and configured to connect the external power source;
a filament disposed within the filament space, partially attached to an inner surface of the envelope, and having
a light-emitting strip having multiple LEDs inside the light-emitting strip; and
an adhering layer disposed at a side of the light-emitting strip and partially attached to the inner surface of the envelope; and
at least one electric wire electrically coupled to the filament and conducting power from the electrical connector to the filament.

2. The LED bulb as claimed in claim 1, wherein
the light-emitting strip has
a conductive framework being an elongated metal sheet and having a front side and a back side facing to opposite directions, and the multiple LEDs disposed at the front side of the conductive framework; and
a top encapsulating layer and a bottom encapsulating layer being translucent and respectively covering the front side and the back side of the conductive framework;
the adhering layer is translucent and disposed at a side, opposite to the conductive framework, of the bottom encapsulating layer; and
a thickness of the bottom encapsulating layer is smaller than a thickness of the top encapsulating layer.

3. The LED bulb as claimed in claim 2, wherein
the conductive framework has multiple openings;
each of the multiple LEDs has two diode emitting faces respectively disposed at two opposite sides of each of the multiple LEDs;
one of the two diode emitting faces of each of the multiple LEDs faces to the conductive framework; and
each of the multiple LEDs emits light via the two diode emitting faces;
the multiple LEDs respectively correspond to the multiple openings in position.

4. The LED bulb as claimed in claim 3, wherein
a thickness of the adhering layer of the filament is smaller than a quarter of a sum of the thickness of the top encapsulating layer and the thickness of the bottom encapsulating layer; and
the thickness of the adhering layer is smaller than two millimeters.

5. The LED bulb as claimed in claim 1, wherein each one of the at least one electric wire is spaced from the inner surface of the envelope.

6. The LED bulb as claimed in claim 4, wherein each one of the at least one electric wire is spaced from the inner surface of the envelope.

7. The LED bulb as claimed in claim 1, wherein the filament is attached to the inner surface of the envelope and forms an enclosed loop.

8. The LED bulb as claimed in claim 4, wherein the filament is attached to the inner surface of the envelope and forms an enclosed loop.

9. The LED bulb as claimed in claim 1, wherein
the containing portion is shaped as a ball;
the filament has a curved attaching section along an elongation direction of the filament;
the curved attaching section is attached to the inner surface of the envelope, is shaped as an arc, and has a center of curvature disposed at a center of the containing portion of the envelope.

10. The LED bulb as claimed in claim 2, wherein
the containing portion is shaped as a ball;
the filament has a curved attaching section along an elongation direction of the filament;
the curved attaching section is attached to the inner surface of the envelope, is shaped as an arc, and has a center of curvature disposed at a center of the containing portion of the envelope.

11. The LED bulb as claimed in claim 4, wherein
the containing portion is shaped as a ball;
the filament has a curved attaching section along an elongation direction of the filament;
the curved attaching section is attached to the inner surface of the envelope, is shaped as an arc, and has a center of curvature disposed at a center of the containing portion of the envelope.

12. The LED bulb as claimed in claim 9, wherein
the curved attaching section of the filament extends along the inner surface of the containing portion over 180 degrees.

13. The LED bulb as claimed in claim 11, wherein
the curved attaching section of the filament extends along the inner surface of the containing portion over 180 degrees.

14. The LED bulb as claimed in claim 1, wherein
the containing portion is shaped as a ball;
the filament is attached to the inner surface of the envelope and has only one curvature;
a ratio of the curvature of the filament and an inside diameter of the containing portion of the envelope ranges from 0.98 to 1, 0.84 to 0.88, 0.68 to 0.72, or 0.48 to 0.52.

15. The LED bulb as claimed in claim 4, wherein
the containing portion is shaped as a ball;
the filament is attached to the inner surface of the envelope and has only one curvature;
a ratio of the curvature of the filament and an inside diameter of the containing portion of the envelope ranges from 0.98 to 1, 0.84 to 0.88, 0.68 to 0.72, or 0.48 to 0.52.

16. The LED bulb as claimed in claim 1, wherein
the LED bulb further has a rotation mechanism connected between the envelope and the electrical connector;
the rotation mechanism has
an envelope connecting portion disposed at the neck portion of the envelope; and
a base connecting portion connected to the envelope connecting portion and being rotatable relative to the envelope connecting portion;
the electrical connector is disposed at the envelope connecting portion of the rotation mechanism.

17. The LED bulb as claimed in claim 2, wherein
the LED bulb further has a rotation mechanism connected between the envelope and the electrical connector;
the rotation mechanism has
an envelope connecting portion disposed at the neck portion of the envelope; and
a base connecting portion connected to the envelope connecting portion and being rotatable relative to the envelope connecting portion;
the electrical connector is disposed at the envelope connecting portion of the rotation mechanism.

18. The LED bulb as claimed in claim 4, wherein
the LED bulb further has a rotation mechanism connected between the envelope and the electrical connector;
the rotation mechanism has
an envelope connecting portion disposed at the neck portion of the envelope; and
a base connecting portion connected to the envelope connecting portion and being rotatable relative to the envelope connecting portion;
the electrical connector is disposed at the envelope connecting portion of the rotation mechanism.

19. The LED bulb as claimed in claim 16, wherein the envelope connecting portion is rotatable relative to the base connecting portion under 360 degrees.

20. The LED bulb as claimed in claim 18, wherein the envelope connecting portion is rotatable relative to the base connecting portion under 360 degrees.
